(19) United States
(12) Patent Application Publication
(10) Pub. No.: US 2010/0054530 A1
(43) Pub. Date: Mar. 4, 2010

(54) System and Method for Data Acquisition and Processing

(76) Inventor: Philip B. Wesby, Stratford-upon-Avon (GB)

Correspondence Address: Sunstein Kann Murphy & Timbers LLP, 125 SUMMER STREET, BOSTON, MA, 02110-1618, US

(21) Appl. No.: 12/446,934

(22) PCT Filed: Oct. 22, 2007
(86) PCT No.: PCT/GB2007/003999

§ 371 Date: Apr. 23, 2009

(30) Foreign Application Priority Data
Oct. 24, 2006 (GB) 0621101.5

(51) Int. Cl. G06K 9/00; G06Q 30/00; G06Q 20/00; G06Q 10/00; G06Q 50/00; G06F 21/00; G06F 15/16; G06K 9/36

(52) U.S. Cl. 382/100; 705/26; 705/44; 705/325; 726/3; 709/206; 382/232

(57) ABSTRACT

A system and method for data acquisition and processing is described which can form the basis of new and improved business and consumer services. Encoded datagram images are captured using a mobile phone or PDA or fixed line device and processed to determine authorisation and level of access to remote data services then transmitted to a remote data processing centre. The captured datagram may comprise a variety of geometric shapes and language characters and even some custom graphics such as the use of a corporate logo incorporated into a datagram structure. The method makes possible payment transactions which link the authentication of the mobile phone subscriber to pre-registered credit facilities such as credit card companies which enables the purchase of music or a software game without requiring the mobile operator to become a general financial credit service.

### BACKGROUND OF THE INVENTION

The invention relates to a system and method for data acquisition and processing.

In particular, the invention relates to a system and method for capturing and or processing a stored or received encoded datagram and either processing it locally in the data capture device or relaying the datagram to a remote server for decoding wherein the datagram or data from it causes a process to occur such as, updated information being sent back to the data capture device, or to some other data receiving device, or wherein the data capture process and communication with the remote data server causes a sequence of processes to occur such as the remote control of equipment.

This patent application extends the invention of an earlier patent application United Kingdom application 0619761.0 by the same applicant entitled System and Method for Data Acquisition and Processing having priority date Oct. 6, 2006. In this patent application is taught the method of using datagrams and combining these with user profiles stored within the data capture device, such as a mobile phone or PDA, to create a range of differentiated services.

The current invention can be considered as key inventive extensions of this technology to payment transactions and to improved methods for building unique datagrams which associate the technology with corporate brands.

Further to the limitations of existing methods used for enhancing data security and data access and data validation, and so far as is known, no optimum system and method for data acquisition and processing is presently available which is directed towards the specific needs of this problem area as outlined.

### OBJECTS OF THE INVENTION

Accordingly, it is an object of the present invention to provide an improved system and method for data acquisition and processing which serves to use a wireless or fixed line device to capture specific encoded visual information in the form of a datagram, combine this information with a pre-stored user profile which can determine access to one or more information services, and transmit a request for access to sought information, to a remote database.

It is a further object of one embodiment of the present invention to provide a system and method for data acquisition and processing which serves to capture and or process specific encoded visual information which is presented in the form of a corporate logo which has been processed into a datagram thereby making possible the use of corporate logos as datagrams which can provide access to differentiated services linked to that corporate identity.

It is a further object of one embodiment of the present invention to provide a system and method for data acquisition and processing which is applicable to wireless payment transactions using a mobile phone camera which combines the use of visually encoded data identifying the product, with the authentication process of the wireless subscriber as determined by the wireless network, and then transmits this to a remote data processing centre so that the payment can be authorised by a pre-registered credit company and thereby make possible a purchase which does not necessarily involve the mobile operator billing the customer for a product purchase.

It is a further object of one embodiment of the present invention to provide a system and method for data acquisition and processing which is applicable to wireless payment transactions whereby the payment transaction request is processed by a data processing centre such as a message transaction server which manages subscriber user profiles and which can authenticate a subscriber, and authorise a payment transaction, and forward a request to make payment to a pre-registered credit company.

It is a further object of one embodiment of the present invention to provide a system and method for data acquisition and processing which is applicable to wireless payment transactions whereby a subscriber captures a datagram which is associated with a product or service, transmits this for authentication and authorisation for payment, and whereby the subscriber receives subsequent confirmation that the payment has been successful and that the product or service has been paid for.

It is a further object of one embodiment of the present invention to provide a system and method for data acquisition and processing which is applicable to wireless payment transactions using mobile phones such as when purchasing a music track or music video or game whereby after authentication of the subscriber and authorisation of the credit payment, confirmation of the transaction is received by the wireless device which initiated the transaction, and the music track or music video or game is then transmitted to either the said wireless device or to an email address or to another IP address.

It is a further object of one embodiment of the present invention to provide a system and method for data acquisition and processing which is applicable to wireless payment transactions wherein, in addition to the subscriber authentication as determined by the network, the transaction may utilise an additional level of security such as requiring the purchaser to enter a specific code, and or answer a specific question in response to a message received from the network.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for data acquisition and processing which can form the basis of a new and exciting portfolio of mobile telecommunications business and consumer services. The diverse nature of the services offers a radical improvement in the quality of life of consumers.

In particular the invention teaches a way to effect payment transactions in a highly efficient and effective way which matches current consumer behaviour and which links to the current modus operandi of wireless operator charging and billing systems and credit companies.

In addition, the invention extends the concept of the visual datagram into the encoding of corporate logos as datagrams so that these can be used to access corporate data and information on company products and differential access to corporate services. The use of the logo-datagram will enable a consumer to easily identify the identity of the company or organisation which is associated with the datagram and access services from it using the system and method of data acquisition.

Other objects and features of the present invention will become apparent from the following detailed description considered in connection with the accompanying drawings, which disclose several key embodiments of the invention. It is to be understood, however, that the drawings are designed for the purpose of illustration only and that the particular description of the data acquisition process and the suggested encoded datagrams are given by way of example only and do not limit the scope of the invention.

### BRIEF DESCRIPTION OF THE DRAWINGS

FIG. 1 illustrates a schematic showing the transformation of a corporate logo into a datagram according to one embodiment of the invention.

FIG. 2 illustrates a schematic showing an example of the combination of a corporate logo with a product datagram.

FIG. 3 illustrates a schematic of a payment transaction which makes use of the system and method of the current invention.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

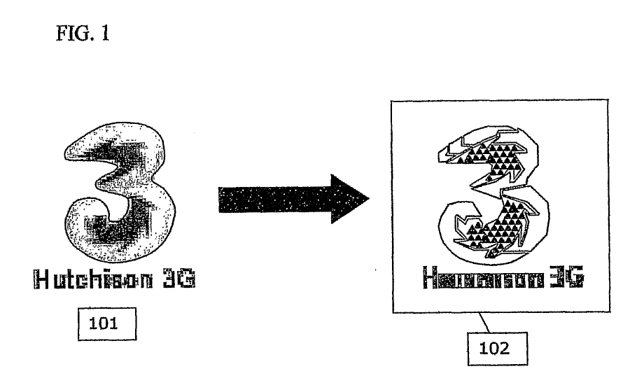

Referring now in detail to the drawings and in particular FIG. 1 thereof, therein illustrated is a schematic of one example showing how a corporate logo can be encoded into a datagram for use by the system and method of the current invention.

A corporate logo, such as this one owned by Hutchison 3G (101) may be encoded into a datagram in a variety of ways. The key elements of the logo design may be reproduced into a pixelated image using a combination of picture elements such as squares of triangles or any combination of geometric shapes according to a predetermined format.

Processing software, either stored in the mobile phone itself or at a remote data server is used to process the data from the datagram. This approach teaches for the first time how corporate logos can themselves act as information bearing images to drive access to all manner of services.

Consequently, the logo itself which carries the powerful brand of the company is immediately identified by consumers and understood to be the gateway to brand-related services such as product information and customer care services.

Customised software makes possible the creation of a differential service profile which will provide access to different types of information and to different services such as transaction services. Corporate employees may thus possess more complex image processing software than consumers while both may capture and transmit the same datagram for processing. It is anticipated that corporate employees may achieve different levels of data access and access to different services from the same datagram in accordance with their job function within the organisation.

Alternatively, through the use of image processing and pixelation of the image in different forms, one can envisage that different datagrams may be used to create the same logo. In these cases, the small differences in the internal structure of the image will link to different services although, ostensibly, the logo will appear almost Identical.

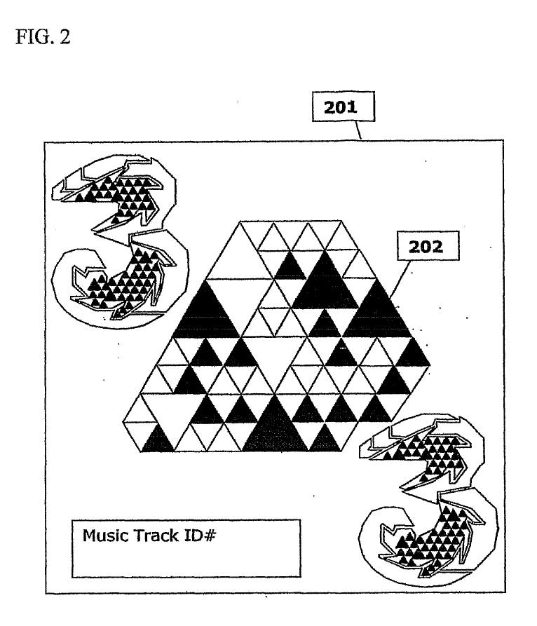

Now with reference to FIG. 2 is shown a datagram which may comprise additional data to the corporate logo datagram. The example attempts to show how a pixelated image, in this case with different patterns of triangles, can combine with a corporate logo and data such as a title which can be understood by a consumer.

This datagram composite image might be suitable for attaching to a CD case or for printing in a magazine or newspaper enabling a consumer to understand the product such as a music track ID, and that capturing the datagram will result in purchase of the music.

The subscription data and user profile may be used to create a data file when combined with data extracted from the datagram which will be used to initiate a payment transaction request.

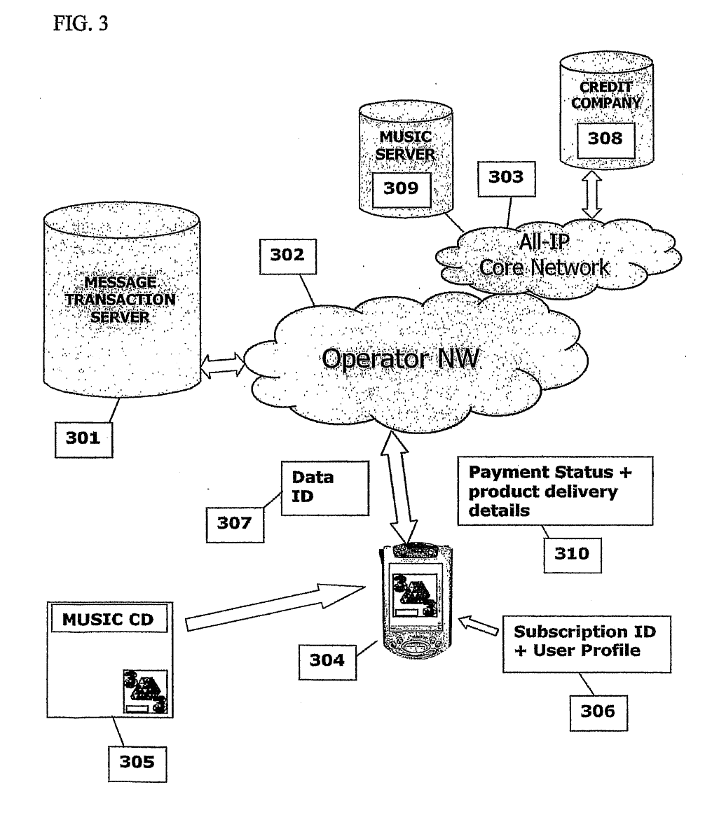

In FIG. 3 is shown a sequence of actions which makes possible an authenticated payment transaction using the current invention.

The system solution makes use of a network capability for managing subscription profiles and service access. In this example, the management and access to services is done via the public network but it is equally envisaged that the data acquisition device may be a device operating in a private network and be linked to private data processing facilities.

The operator network (302) comprises a data processing centre, here termed a message transaction server (301) although it should be understood strictly in terms of its function and not interpreted by its name. The data processing centre (301) hosts profiles of subscribers within the network who each have access to different network services by virtue of their subscription and or job function and or additional subscribed services.

The operator network (302) is connected to an all-IP core network 303), which itself links to the Internet and to a whole range of corporate services such as credit companies and the like.

To effect a payment transaction, a consumer selects a music CD (305), for example, and captures the datagram on the outside of the CD case using a PDA (304).

Software on the PDA device (304) processes the image and may extract the destination to which a data file or Data ID (307) will be sent. Alternatively, the entire datagram is sent to be processed remotely by a predetermined preset number.

In the first phase of the payment transaction, the data ID (307) may be created with reference to a subscriber ID and user profile (306). This affords the facility to link the subscriber with a set of pre-approved services such as payment by credit card.

The data ID (307) is sent to the network for processing by the data processing centre (301) and after authentication and authorisation, a data file is transmitted to the credit company (308) for approval of the transaction. If this is successful the product is authorised for dispatch to the consumer from a music server (309) and either sent directly back to the subscribers mobile phone or PDA and or sent to a pre-designated email address.

A payment status message (310) indicating product delivery details is then sent to the device requesting the purchase transaction.

According to different legal and operation requirements, additional levels of security may be added such as requesting a PIN code when making the purchase transaction or answering different security questions received back from the network.

The current invention further clarifies how retailers can link opt-in advertising with conventional credit companies and thereby make possible the targeting and payment transaction for the purchase of products and services.

Response from a datagram capture may result in targetted advertising which specifically invites a consumer to purchase a product according to the method of the current invention.

It should be understood however, that the present disclosure is for the purpose of illustration only and does not include all modifications or improvements, which will become obvious to the man skilled in the art in the light of this publication which may fall within the scope of the appended claims.

What is claimed is:

1. A wireless service applications system comprising a data acquisition device comprising pre-programmed decoding and/or encoding and/or formatting software according to a stored dataset comprising user access rights for capturing and processing encoded datagram images characterised by
said data acquisition device further comprising received or pre-stored image processing datasets for processing said datagram image with said image processing datasets according to said user service access rights wherein said processing being different for each of said user service access rights, and
a remote processing server for managing end-to-end applications between said data acquisition device and said remote processing server, and
an operator network comprising a data processing centre hosting a plurality of profiles of a plurality of said users each having access to one or a plurality of network services according to their service access rights

2. A wireless service applications system according to claim 1 wherein said encoded datagram images comprising all or part of an encoded corporate brand or trade mark or logo, and
different levels of services being delivered in accordance with said service access rights, and
said data acquisition device being a wireless multimedia computer, a PDA or a mobile phone, or a fixed image capture device, and
said services being product information and/or customer care services, and/or corporate services and/or car park access services and/or ATM cash withdrawal transaction services and/or product purchase services, and/or
said received or pre-stored image processing datasets comprising one or more inverse images either pre-stored or received by said data acquisition device for combining part of or one or a plurality of said inverse images with said captured encoded corporate brand or trademark or logo for accessing one or a plurality of services in accordance with said service access rights.

3. A wireless service applications system according to claim 2 further wherein
said data acquisition device further comprising software creating a differential service profile for providing access to different types of information and/or one or a plurality of said services and/or transaction services, wherein
different levels of service access being provided by providing different users with image processing software comprising different datasets according to their subscription and/or job function to enable different users to process said captured encoded datagram comprising said corporate brand or trade mark or logo in different ways.

4. A wireless service applications system according to claim 3 wherein said datagram image further comprising
additional information data comprising one or a plurality of predetermined patterns of geometric shapes and/or gridlines, wherein
said different information data contained in said datagram image links the datagram to different products and services.

5. A wireless service applications system according to claim 4 wherein
said datagrams being printed or displayed on different media each being a paper sheet or vinyl sheet or a billboard or an electronic screen of a computer terminal or LCD screen or television screen or a magazine or newspaper, or the surface of a product packaging or upon the surface of a product itself.

6. A wireless service applications system according to claim 5 further comprising
means for initiating an authenticated payment transaction request to a payment centre by combining user identification data with said captured datagram.

7. A wireless service applications method comprising a data acquisition device comprising pre-programmed decoding and/or encoding and/or formatting software according to a stored dataset comprising user access rights for capturing and processing encoded datagram images for accessing a service or information or purchasing a product said method being characterised by the steps of
capturing said encoded datagram image using a data acquisition device,
selecting an image processing dataset according to said user access rights
processing the captured datagram with one or a plurality of received or stored image processing datasets
compiling a data message, and either
processing locally said encoded datagram image and/or extracting the destination to which a data file or Data ID is to be sent or
sending said entire encoded datagram image to be processed by a remote data processing centre.

8. A wireless transactional service applications method according to claim 7 wherein
said encoded datagram image comprising all or part of an encoded corporate brand or trade mark or logo, and
different levels of services being delivered in accordance with said service access rights, and
said data acquisition device being a wireless multimedia computer, a PDA or a mobile phone, or a fixed image capture device, and
said services being product information and/or customer care services, and/or corporate services and/or car park access services and/or ATM cash withdrawal transaction services and/or product purchase services, and/or
said received or pre-stored image processing datasets comprising one or more inverse images either pre-stored or received by said data acquisition device for combining part of or one or a plurality of said inverse images with said captured encoded datagram for accessing one or a plurality of services in accordance with said user's service access rights.

9. A wireless service applications method according to claim 8 further comprising the steps of;
creating a differential service profile for providing access to different types of information and/or one or a plurality of said services and/or transaction services by said data acquisition device further comprising software, wherein
different levels of service access being provided by providing different users with image processing software comprising different levels of complexity according to their profile to enable the captured datagram to be processed in different ways

10. A wireless service applications method according to claim 9 further comprising the steps of;
decoding additional information data comprising one or a plurality of predetermined patterns of geometric shapes and/or gridlines, wherein
said different information data contained in said datagram image appearing almost identical, for associating the datagram with different products and or services.

11. A wireless service applications method according to claim 10 wherein the transaction comprising purchasing a product or service further comprising the steps of:
sending said data to the network for processing by said message transaction server authenticating said transmitted data message, and/or,
transmitting a data file to a credit company for approval of the transaction and/or said credit company requesting from the user further authentication such as a PIN code or answers to different security questions to authorise the transaction

12. A wireless service applications method according to claim 11 wherein
said datagrams being printed or displayed on different media each being a paper sheet or vinyl sheet or a billboard or an electronic screen of a computer terminal or LCD screen or television screen or a magazine or newspaper, or the surface of a product packaging or upon the surface of a product itself.

13. A wireless service applications method according to claim 12 wherein the transaction comprising purchasing a product or service wherein when said product being music and or image and or data content
either directly sending back the said content to the datagram capturing device and/or sending said content to a pre-designated email or IP address.

14. A wireless service applications method according to claim 13 further comprising the steps of
sending a payment status message indicating said content delivery details to the device requesting said purchase transaction.
